(19) United States
(12) Patent Application Publication
(10) Pub. No.: US 2003/0086168 A1
(43) Pub. Date: May 8, 2003

(54) Highly tunable dispersion compensator

(75) Inventors: Nigel Copner, Sebastopol, CA (US); Kim Tan, Sunnyvale, CA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, San Jose, CA (US)

(21) Appl. No.: 10/271,650

(22) Filed: Oct. 16, 2002

Related U.S. Application Data
(60) Provisional application No. 60/329,848, filed on Oct. 16, 2001.

(51) Int. Cl. G02B 5/30; G02B 27/28; G02B 27/00; G02B 5/04

(52) U.S. Cl. 359/484; 359/577; 359/615

(57) ABSTRACT

A method and device for providing tunable dispersion compensation by splitting an incoming optical beam and then recombining interferometrically two sub-beams which have been passed through fixed dispersive (dispersion producing) elements. The polarization of the incoming optical signal is controlled and the signal beam is split into sub-beams at a ratio dependent on the polarization. The sub-beams are directed to each of two interferometer arms. The return beams are interfered e.g. by placing a quarter waveplate at 45° to the two orthogonal polarization axes. This produces a near-lossless beam with a tunable amount of dispersion dependent on the ratio of beam split.

### RELATED APPLICATIONS

This application claims priority from U.S. provisional application No. 60/329,848 filed Oct. 16, 2001.

### TECHNICAL FIELD

This invention relates to dispersion compensation in optical networks and in particular to a method and a device for providing dispersion compensation of an optical signal by beam splitting and interferometric beam recombining without the need of an opto-mechanical or a thermo-optic effect in the control mechanism.

### BACKGROUND ART

With increasing demands on configurability in optical networks, dynamic dispersion compensators and gain equalizers are becoming increasingly important. Known dispersion compensators are based on multi-cavity GT etalons as taught e.g. in US publ. patent application No. 20010021053 (and European patent application No.EP1 098 212 A1) in the name of Colbourne, et al.; on chirped fiber Bragg gratings (FBGs), as disclosed in U.S. Pat. No. 5,909,295 in the name of Li et al., and in U.S. Pat. No. 5,701,188 assigned to Sumitomo Electric Industries, Ltd.; on the use of planar lightwave circuit (PLC) delay equalizers, etc. In all the cases the tuning mechanism relies on temperature setting or mechanical movement.

It is desirable to eliminate the thermal or mechanical control of the dispersion compensator and speed up its response time. It is also an object of the invention to provide a device for continuous dispersion compensation.

### SUMMARY OF THE INVENTION

In accordance with the invention, there is provided a device for introducing a predetermined amount of dispersion into an optical signal beam, the device comprising:

a beam splitting means for splitting an optical input beam into two sub-beams at a predetermined optical power split ratio,

beam split control means for controlling the optical power split ratio,

at least one dispersive element for introducing a predetermined amount of dispersion into one of the sub-beams,

combining means for recombining the sub-beams after the predetermined amount of dispersion has been introduced into one of the sub-beams, and

interference means for producing a single interfered output beam having a predetermined amount of dispersion dependent on the split ratio and the amount of dispersion introduced into at least one of the sub-beams.

In accordance with another aspect of the invention, there is provided a method for introducing a predetermined amount of dispersion into an optical beam, comprising:

providing an input optical beam,

splitting the input optical beam into two sub-beams at a predetermined optical power split ratio,

introducing a predetermined amount of dispersion into at least one of the two sub-beams, then

recombining the two sub-beams and interfering them together to produce a single output optical beam having a predetermined amount of dispersion, the amount dependent on the power split ratio and the predetermined amount of dispersion introduced into at least one of the sub-beams.

In accordance with another aspect of the invention, there is provided a dispersion compensating device for compensating a dispersion of an optical input beam, the device comprising:

variable beam splitting means for splitting the optical input beam into two sub-beams having each a variable part of the optical power of the input beam, the variable parts defining an optical power split ratio,

a first and a second optical element coupled each for receiving and reflecting one of the sub-beams, at least one of the optical elements for introducing a predetermined amount of dispersion into the respective sub-beam, and

interference means for interfering the reflected sub-beams to produce an interfered output beam having a dispersion dependent in a predetermined manner on the optical power split ratio and on the amount of dispersion introduced by the at least one optical element into the sub-beam.

The at least one optical element for introducing a predetermined amount of dispersion is called a dispersive element. It can be one of: an etalon, including multi-cavity etalon, a fiber Bragg grating, a diffraction grating, a dispersive prism.

The control means may be a polarization rotation control means.

### BRIEF DESCRIPTION OF THE DRAWINGS

The invention will be explained in more detail by way of the following description in conjunction with the drawings in which

FIG. 1 shows a prior art Gires-Tournois etalon-based Michelson interferometer configuration,

FIG. 2 illustrates vector sum of interferometer components,

FIG. 3 shows intensity and phase response of a Michelson interferometer having a GT arm and a plane mirror arm,

FIG. 4 illustrates continuous dispersion changes for the interferometric output as the split ratio of the beamsplitter is varied,

FIG. 5 illustrates an embodiment of the invention using a polarization based interferometer with a chirped fiber Bragg grating,

FIG. 6 illustrates schematically the principle of a prior art interferometric tunable dispersion compensator,

FIG. 7 illustrates the invention in terms of dispersion slopes, and

FIG. 8 is a block diagram illustrating the invention in generic terms.

### DETAILED DESCRIPTION OF THE EMBODIMENTS OF THE INVENTION

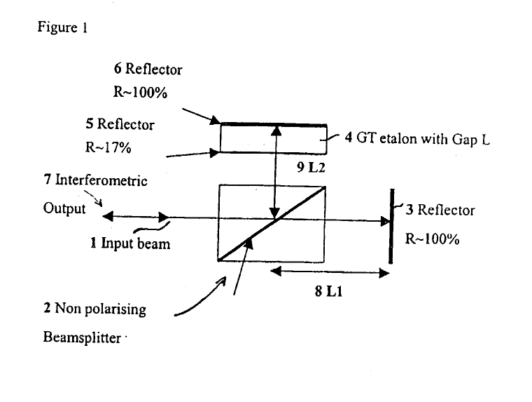

FIG. 1 shows an exemplary prior art Michelson interferometer having a Gires-Tournois (GT) etalon 4 in one arm and a simple mirror 3 in the other arm. The GT etalon is a Fabry-Perot etalon having one substantially fully reflective end face 6 and a partially reflective front face 5. Such device is described e.g. in a paper entitled “Multifunction optical filter with a Michelson-Gires-Tournois interferometer for wavelength-division-multiplexed network system applications”, by Benjamin B. Dingle and Masayuki Izutsu published in 1998, by the Optical Society of America. The device as exemplified in FIG. 1 serves as a narrow band wavelength demultiplexor; it relies on interfering an E-field reflected by the GT etalon 4 with an E-field reflected by a plane mirror 3. The etalon 4 has a 99.9% reflective back reflector 6 and a front reflector 5 having a reflectivity of about 10˜20%; hence an output signal from only the front reflector 5 is utilized.

Let us assume that the input light 1 beam is split at the surface of a beamsplitter 2 exactly 50/50. For this example, the nominal optical path difference 8 (L1) and 9 (L2) in the system is assumed to be zero. For a standard Michelson interferometer with standard reflectors in both arms (i.e. no GT etalon) the dispersion is near zero for any given optical path difference since the optical phase difference varies linearly with wavelength. However, it has been predicted and experimentally observed that the dispersion of the interferometric output for the device shown in FIG. 1 is approximately half the dispersion of the GT Etalon. The interferometer appears to track the average dispersion when the split ratio of the beamsplitter is 50/50. This finding has led to the present invention.

Let us assume that the complex amplitudes of the two combining light components of the output beam 7 are:

Aexp[jα(λ)] for the GT arm and Bexp[jβ(λ)]

for the plane mirror arm, where

α is the phase dependence of reflected field of GT etalon:

$$α ( λ , R , d ) = - 2 {tan}^{- 1} ( \frac{1 - \sqrt{R}}{1 + \sqrt{R}} tan ( \frac{2 π n d}{λ} ) ) ,$$

, where R is the front reflectivity of the GT etalon, d is the GT etalon cavity length and n is the index of refraction of the cavity medium.

β is the phase dependence of the reflected field of the plane mirror:

$$β ( λ , L2 , L1 - d ) = \frac{2 π n}{λ} ( L2 - ( L1 - d ) ) ,$$

where L2 is the path before the plane mirror, L1−d is the path before the GT etalon of cavity length d. It is assume that the path media and the etalon medium have the same index of refraction (e.g. n=air index).

A is the magnitude of the reflected field of the GT etalon, and

B is the magnitude of the reflected field of the plane mirror.

For the case of equal split, the output complex amplitude is:

Cexp[jφ(λ)], where φ(λ)=[α(λ)+β(λ)]/2.

For the GT Michelson interferometer, α is non-linearly dependent on wavelength whereas β is linearly dependent on wavelength.

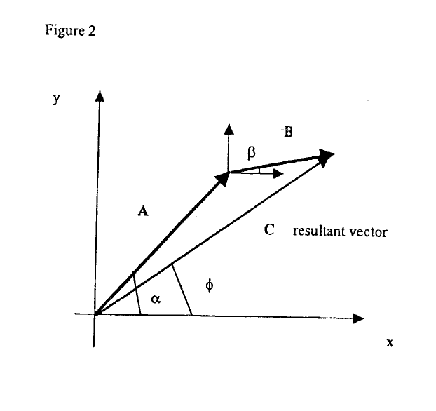

The resultant wave (FIG. 2) has therefore reduced non-linear dependence and reduced dispersion, which is the second derivative of the phase variation across wavelength space.

In order to tailor the amount of dispersion, the phase profile of the resultant output has to be controlled. In this case, the output phase is given by:

tan[φ(λ)]={A sin[α(λ)]+B sin[β(λ)]}/{A cos[α(λ)]+B cos[β(λ)]}.

It is obvious that the ratio of beam split, A:B dictates the output phase profile, and hence its group delay and dispersion properties, in the above device configuration.

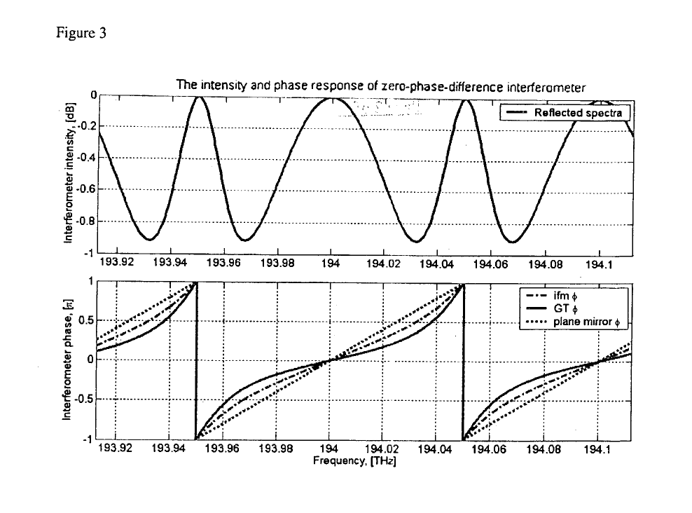

FIG. 3 demonstrates that the non-linear phase dependence of the reflected field of a GT etalon is reduced by the addition of a linear-phase plane mirror in a Michelson interferometer configuration. A plane mirror has a linear phase dependence with wavelength or frequency, inferring that the group delay being the first derivative of phase will be a constant and the chromatic dispersion being the second derivative will be zero. On the other hand, a 19% front reflectance and 99% back reflectance GT etalon has a rather large phase non-linearity with respect to wavelength or frequency. By combining the GT etalon and the plane mirror elements, the chromatic dispersion has been reduced. Michelson interferometer is an ideal configuration for combining these two element because the interference produces a near lossless output as has been illustrated by the intensity profile in the top plot of FIG. 3.

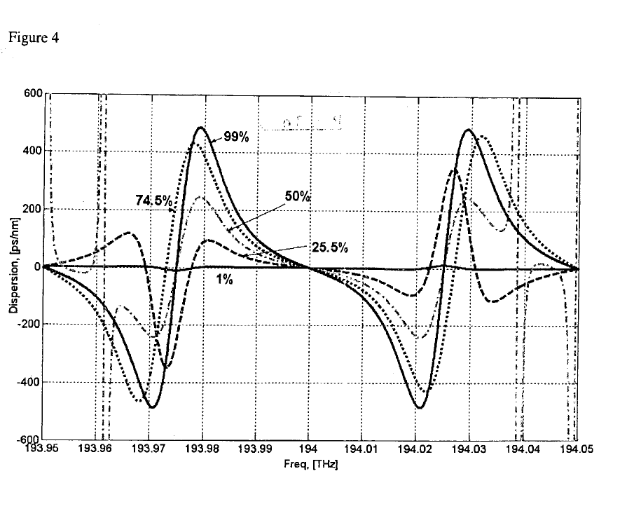

FIG. 4 shows a plot of the dispersion of the interferometric output as the split ratio is varied. The plot shows separate curves for different split ratio, from 1 to 99% i.e. for example the dispersion trace labelled ‘99%’ has 99% of the input light incident on the GT etalon and only 1% sees the high-reflectivity (HR) plane mirror. It is clear that the dispersion of the resulting interferometric output can be varied continuously. For instance if more of the light is directed to reach the GT etalon, the dispersion of the interferometer output will tend towards that of the GT etalon. Conversely, if more light is allowed to pass to the mirror, the dispersion tends to become zero. The relationship is not defined mathematically herein but it is the second derivative of the mathematical expression of interferometric phase given in paragraph [19].

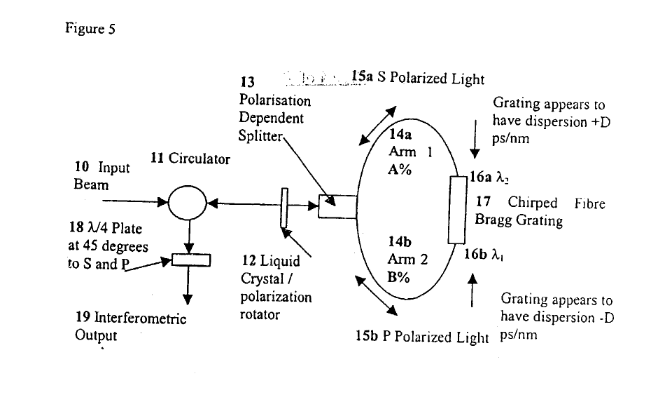

The above-discussed interferometric effect is used, according to the invention, to provide continuous dispersion required for compensation purposes in new optical networks. An exemplary tunable dispersion controlling device of the invention is shown in FIG. 5. The control mechanism utilized here is polarization of the input light 10. A polarization rotation mechanism 11 exemplified by a liquid crystal optic axis rotator can be used to orient the linear polarization of input beam 10 in desired direction. It is assumed that the polarization of the input beam 10 is known, or a polarization diversity scheme can be put in place.

The light then travels to a polarization-sensitive device such as a polarizing-beam splitter (PBS) 13. This device separates the s- and the p-polarized light in two orthogonal directions or two non-orthogonal paths. The two paths make up the two arms of the Michelson interferometer (PBS 13, arm 14a, arm 14b and chirped fiber Bragg grating 17). The ratio of s- and p-polarized light traveling around arms 14a and 14b (A:B respectively) is dictated by the output polarization of the rotation device (liquid crystal rotator 12). One can easily select a polarization such that all the light directed into the PBS exits at arm 14a, or all the light exits at arm 14b or at any ratio between 0 and 100%. The two arms of the interferometer are connected by a dispersive element, a conventional chirped fiber Bragg grating (FBG) 17 as shown in FIG. 5.

Using a single dispersive element and joining the two arms is not a necessity for the invention. Each interferometer arm can be directed to one or more dispersive elements such as multi-cavity etalons, dispersive fibers, dispersive prisms, diffraction gratings etc. devices introducing group delay into at least one sub-beam undergoing interference with another sub-beam.

An FBG is a wavelength sensitive device that transmits and reflects pre-determined bands of light. One useful function of an FBG is band-pass/band-stop filtering. However, when the period of index profile written into the core of the FBG is slowly varied (so-called chirp) across the length of the grating, the length typically in the order of millimeters, different wavelength components of a broadband light source are reflected at the FBG 17 with varying delays. In the example shown, λ₁ is shorter than λ₂. Hence, the p-polarized light injected into the FBG has shorter wavelengths reflected first. The longer wavelength components are delayed further, which counteracts the delays in a typical transmission fiber. A typical optical glass medium for light wave propagation has a lower index of refraction for the longer-wavelength waves. Hence, in a conventional use, the FBG compensates for the unequal delays of short and long wave propagation. The FBG can be considered as a dispersive element, or dispersion-introducing element, in which the light components in arm 14b have been subjected to a negative dispersion. Simultaneously, light components injected into the FBG from arm 14a experience a positive dispersion.

The light components in the two arms of the interferometer are then returned to a beam combining element 13. The PBS 13 in reverse operation acts as a beam combiner.

Using a single element functioning as beam splitter and beam-combiner is not a necessity for the purposes of the invention. The two arms of the interferometer can be brought together by an additional element, whether the components backtrack the original paths or not. Using a circulator or any device or method where the input and output beams are spatially separated, these returning components can be directed to a different port.

Without considering non-linear effects, interference of light components from the two arms of the interferometer can only occur for a light beam of the same wavelength and state of polarization. In order to effect the interference for the purposes of the invention, a quarter waveplate 18 is provided at 45° to the two polarization components S and P outputs. Assuming that all the elements up to this stage, with the exception of the polarization rotator 12, do not alter the state of polarizations, the outputs prior to the quarter waveplate 18 are spatially overlapped but otherwise separated by orthogonal linear polarizations. The function of the quarter waveplate 18 is to bring the two polarization components (at the same wavelength, but with different amount of positive and negative dispersion) to interfere. The output 19 of the interferometer is then injected back into the fiber networks with a desired net dispersion.

Generally, the light which travels around arm 14a, i.e. S-polarized light will see a chirped grating of dispersion D ps/nm. Light traveling in arm 2 i.e. P-polarized light will see a chirped grating of dispersion −D ps/nm. The use of a liquid crystal 12 (polarization rotator) and the polarization beam-splitter (PBS) allows an effective split ratio change in the interferometer.

The following states illustrate a potential outcome of the interferometric tunable dispersion compensator of FIG. 5:

State 1: Input light to PBS is all S-polarized

All light enters arm 14a and is reflected from the chirped fiber Bragg grating. Dispersion D ps/nm is observed.

State 2: Input light to PBS is all P-polarized

All light enters arm 14b and is reflected from the chirped fiber Bragg grating.

Dispersion −D ps/nm is observed.

State 3: Input light to PBS contains 50% S-polarized and 50% P-polarized light.

Light is split equally between arm 1 and arm 2. The interferometer output will follow the average dispersion i.e. (D−D)/2=0 ps/nm.

State 4: In addition, the dispersion of the interferometer output (reflected) can be continuously adjusted by changing the input polarization to the PBS. Different fractions of light experiencing +D and −D dispersion will be combined to provide any dispersion value from −D to +D, i.e. net dispersion is r×D−(1−r)×D, where r is the fraction of the input light directed towards arm 1.

The advantages of the polarization-based tuning mechanism of the embodiment of FIG. 5 are discussed below.

Using a liquid crystal cell, the dispersion can be adjusted from D to −D ps/nm in less than 10 microseconds without a loss penalty. Also, the chirped fiber Bragg grating undergoes no straining and hence reliability, stress-induced birefringence etc. do not pose a problem. In the interferometer of FIG. 5, the fiber Bragg grating 17 may be placed so that the effective path difference is zero. Even if there is quite a substantial group delay variation along the chirped grating, the optical phase varies by a small amount, i.e. 10 nm chirp would correspond to 10/1550 fractional change in the phase. Therefore the interferometric intensity should not vary significantly.

If the embodiment of FIG. 5 is modified into a non-interferometric approach, the output may consist of two beams of different dispersions and the intensity of the two or more beams would be the only variable. The beating of the two or more beams interferometrically produces a single output beam with a dispersion dependent on the relative strengths of the beams and their respective dispersions.

The concept of the invention has been demonstrated with GT etalons and fiber Bragg gratings but it can further be used with any dispersion component i.e. multi-cavity etalons (GT etalons included), dispersive fiber, dispersive prisms, diffraction gratings etc.

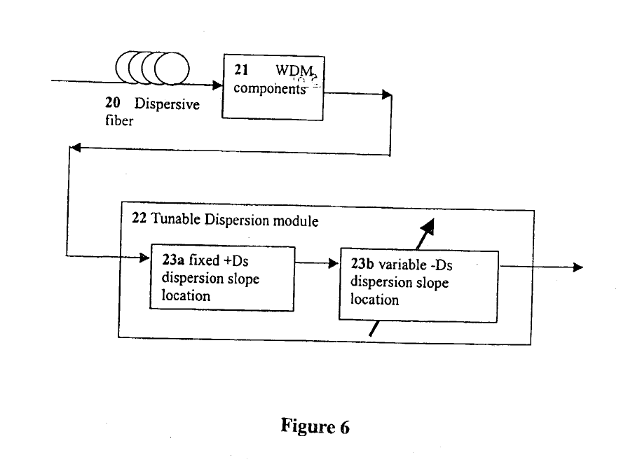

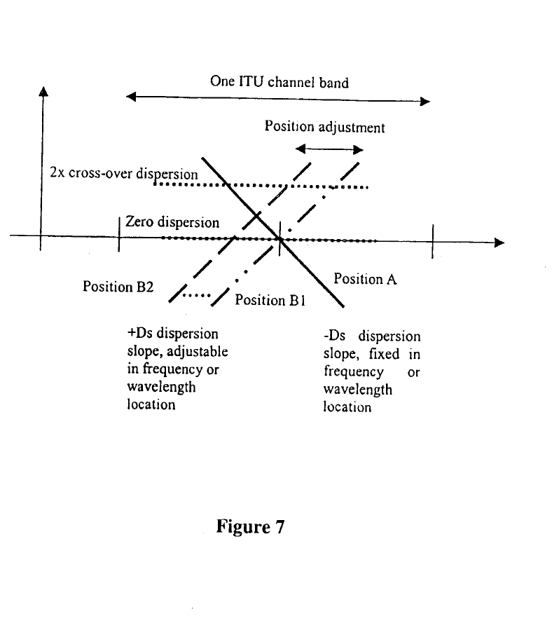

Turning now to FIG. 6, a generic representation of the known (prior art) tunable dispersion compensator is illustrated schematically. One or both the dispersive elements (23a and 23b) can be adjusted in the frequency alignment position, in order to effect a net dispersion profile. A section of a dispersive fiber 20 and a WDM element 21 denote optical network elements where an optical signal beam has experienced some dispersion and some compensation of dispersion has to be provided before the optical signal is fed to a detection system. In this prior art dispersion compensation scheme, the crossing of two dispersion profiles is shown in FIG. 7, whereby one profile is stationary and another slides pass the first profile to give approximately twice the dispersion value at the cross-over point within the bandpass region.

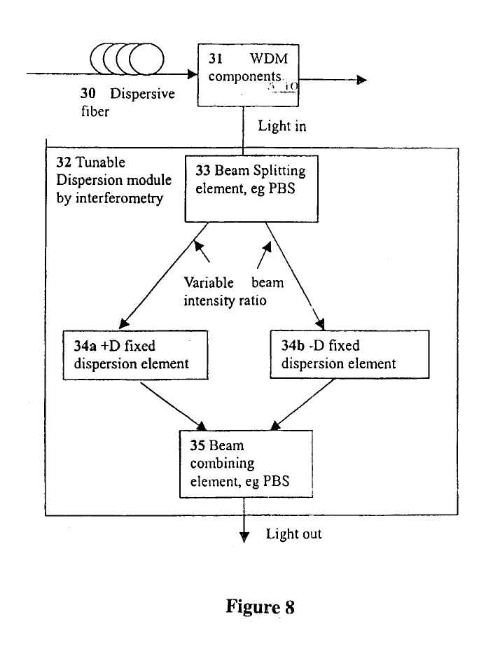

In contrast to the prior-art dispersion compensation scheme, this invention does not rely on the optical beam being fed into two elements in series. FIG. 8 shows a generic configuration of a device of the invention with beam splitting, propagation of sub-beams in the separate arms and the eventual recombination of the two sub-beams by a separate element forming an interferometer. Each arm of the interferometer may have its own dispersive elements. The signs of the dispersion of these elements are opposite but not necessarily the same magnitude. The two dispersive elements may or may not have a dispersion slope. This design gives flexibility in the selection of the various components making up the interferometer. In FIG. 8, a dispersive fiber 30 coupled with a WDM component 31 are optical network elements where some dispersion has been imposed on the travelling optical signal. Before the information carried by optical signal is detected, the light beam is first conditioned by a tunable dispersion compensation module 32. This module essentially contains an interferometer, having a beam splitting element 33, two fixed dispersion elements 34a and 34b, and a beam combining element 35.

This generic embodiment allows for flexibility in the selection of the various elements of the interferometric tunable dispersion compensator. The beam splitting element may function based on polarization as depicted in FIG. 5, or it may be an intensity splitter, a 3 dB fused fiber coupler, waveguide coupler, mirror etc. The two optical paths forming the interferometer arms can be free-space or guided wave propagation media. The one or more dispersive elements can be a fiber Bragg grating, a GT etalon, a plane mirror, a diffraction grating, a multi-cavity etalon, a dispersion compensation fiber, a dispersion compensation module of any technology, fixed or tunable. The beam combining element can be another intensity splitter, polarizing beam splitter, directional couplers, mirrors etc.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

1. A dispersion compensating device for compensating a dispersion of an optical input beam, the device comprising:
variable beam splitting means for splitting the optical input beam into two sub-beams having each a variable part of the optical power of the input beam, the variable parts defining an optical power split ratio,
a first and a second optical element coupled each for receiving and reflecting one of the sub-beams, at least one of the optical elements for introducing a predetermined amount of dispersion into the respective sub-beam, and
interference means for interfering the reflected sub-beams to produce an interfered output beam having a dispersion dependent in a predetermined manner on the optical power split ratio and on the amount of dispersion introduced by the at least one optical element into the sub-beam.

2. The dispersion compensating device of claim 1 wherein the variable beam splitting means comprises a split ratio control means for controlling the optical power split ratio in a continuous manner.

3. The device of claim 2 wherein the variable beam splitting means comprises a polarization rotator and a polarization beam splitter coupled with the rotator, for providing a predetermined optical power split ratio.

4. The device of claim 1 wherein the interference means is a quarter waveplate coupled to interfere said reflected sub-beams.

5. The device of claim 1 wherein said first and second optical element is a fiber Bragg grating coupled with the splitting means via two arms.

6. The device of claim 1 wherein at least one of the optical elements is a GT etalon.

7. The device of claim 1 wherein at least one of the optical elements is a dispersive fiber.

8. The device of claim 1 wherein at least one of the optical elements is a diffraction grating.

9. The device of claim 2 wherein the polarization rotator is a liquid crystal rotator.

10. A device for introducing a predetermined amount of dispersion into an optical signal beam, the device comprising:
a beam splitting means for splitting an optical input beam into two sub-beams at a predetermined optical power split ratio,
beam split control means for controlling the optical power split ratio,
at least one dispersive element for introducing a predetermined amount of dispersion into one of the sub-beams,
combining means for recombining the sub-beams after the predetermined amount of dispersion has been introduced into one of the sub-beams, and
interference means for producing a single interfered output beam having a predetermined amount of dispersion dependent on the split ratio and the amount of dispersion introduced into at least one of the sub-beams.

11. A method for introducing a predetermined amount of dispersion into an optical beam, comprising:
providing an input optical beam,
splitting the input optical beam into two sub-beams at a predetermined optical power split ratio,
introducing a predetermined amount of dispersion into at least one of the two sub-beams, then
recombining the two sub-beams and interfering them together to produce a single output optical beam having a predetermined amount of dispersion, the amount dependent on the power split ratio, and the predetermined amount of dispersion introduced into at least one of the sub-beams.
